(19) United States
(12) Patent Application Publication
(10) Pub. No.: US 2012/0097268 A1
(43) Pub. Date: Apr. 26, 2012

(54) FILLING CONTROL DEVICE FOR A HYDRODYNAMIC MACHINE

(76) Inventor: Dieter Laukemann, Crailsheim (DE)

(21) Appl. No.: 13/304,937

(22) Filed: Nov. 28, 2011

Related U.S. Application Data
(63) Continuation of application No. PCT/EP2011/000455, filed on Feb. 1, 2011.

(30) Foreign Application Priority Data
Feb. 5, 2010 (DE) 10 2010 007 149.8

(51) Int. Cl. F16K 17/00

(52) U.S. Cl. 137/528

(57) ABSTRACT

The invention concerns a filling control device of a hydrodynamic machine having two inlets and two outlets as well as two valve bodies. The two valve bodies can be shifted by means of a piston rod, to control the flow of working medium in the inlets and outlets as an open or closed-loop. The invention is characterised in that that the first valve body is connected elastically on the piston rod and that a stationary stop is provided for the first valve body, against which the first valve body strikes when the second valve body is further shifted by means of the piston rod.

This is a continuation of PCT application No. PCT/EP2011/00455, entitled “FILLING CONTROL DEVICE FOR A HYDRODYNAMIC MACHINE”, filed Feb. 1, 2011, which is incorporated herein by reference.

### BACKGROUND OF THE INVENTION

1. Field of the Invention

The invention concerns the field of hydrodynamic machines, and in particular a filling control device of a hydrodynamic machine, respectively a hydrodynamic machine (for instance a retarder) having such a filling control device.

2. Description of the Related Art

Hydrodynamic machines contain a workspace, which can be filled with a working medium in order to transmit the drive power respectively the torque from the primary wheel of the hydrodynamic machine, also called pump wheel, to the secondary wheel of the hydrodynamic machine, also called turbine wheel. In a hydrodynamic retarder, the turbine wheel is stationary and is hence also called stator.

The transmitted drive power from the pump wheel to the turbine wheel respectively the transmitted torque depends on the level of filling of the workspace of the hydrodynamic machine, which is formed by both blade wheels, pump wheel and turbine wheel. In particular, the transmitted power respectively the transmitted torque increases together with the level of filling, starting from a completely or practically emptied condition (idle) up to a filled-up condition. The adjustment of a certain level of filling of the workspace with working medium can hence control the power transmission of the hydrodynamic machine.

Previously, the hydrodynamic machine, for instance a retarder, was controlled via two valves operated separately, which machine for instance is designed as a water retarder like in an embodiment of the present invention, that is to say its working medium water comes for instance from the cooling water system of a motor vehicle. The first valve is a switching valve, for instance a 3/2-2 directional valve, which only exhibits the On and Off conditions. The flow of working medium is guided by means of this switching valve either completely to the retarder or past said retarder, that is to say through a by-pass to the retarder. The second valve is a regulating valve, which is provided behind the working medium outlet of the retarder as seen in the flow direction of the working medium and regulates the working medium pressure in the workspace of the retarder and hence the transmitted power and the transmitted braking torque.

The known embodiments hence require two valves provided close to one another, which must be operated by a control pressure.

A known further embodiment sets forth that the function of both separate valves should be regrouped in a so-called combination valve. Thus document DE 10 2006 008 110 describes a filling control device for a hydrodynamic machine, in particular a retarder, having two inlets and two outlets for supplying working medium into the hydrodynamic machine and discharging working medium from the hydrodynamic machine. Moreover, two valve bodies as well as a force transducer and/or displacement sensor are provided, which are regrouped in a common control valve together with the inlets and outlets and they control in an open or closed loop the flow of working medium in the inlets and outlets according to the position of the valve bodies, which position is determined by the action exerted by the force transducer and/or displacement sensor. The characteristics of this filling control device are summarized as follows:

A filling control device of a hydrodynamic machine, in particular for a retarder,
having a first inlet for supplying working medium for the hydrodynamic machine into the filling control device;
having a second inlet for supplying working medium from the hydrodynamic machine into the filling control device;
having a first outlet for discharging working medium into the hydrodynamic machine;
having a second outlet for discharging working medium from the hydrodynamic machine and/or working medium from a bypass, which carries working medium passed the hydrodynamic machine;
having a force transducer and/or displacement sensor or a port for such a sensor; wherein
all the aforementioned inlets and outlets together with the force transducer and/or displacement sensor or the port therefore are provided in a common control valve, which has a first and a second valve body, which are acted upon by the force transducer and/or displacement sensor to shift them together in such a way that they control at least indirectly the flow of working medium in the inlets and outlets as an open or closed-loop and/or between them according to the action exerted by the force transducer and/or displacement sensor as a result of their being shifted; and
the first valve body and the second valve body are shifted by means of a piston rod which can be shifted by the force transducer and/or displacement sensor;
the first valve body is acted upon in a direction of shift by the working medium pressure in the first inlet or by a pressure dependent thereon and
the second valve body when being shifted alters the pressure of the working medium and/or the free flow cross-section for working medium in the second inlet; and
the first valve body and the second valve body are connected to one another via the piston rod or another rigid element and/or an elastic element.

Investigations on a hydrodynamic water retarder, which was fitted with the above filling control device, have shown that the actual braking torque, which can be achieved with the retarder, varies according to the engine speed of an internal combustion engine, in which drive train the retarder is installed. It could thus be noted that the retarder braking torque increases together with the engine speed.

Reference is made to the following prior art documents:
DE 198 33 891 A1
DE 29 23 406 C3
DE 26 35 154 A1
DE 12 85 902 A
DE 74 29 240 U

It is the object of the invention, and what is needed in the art is, to improve the described filling control device of a hydrodynamic machine, in particular of a retarder, in such a way as to avoid any undesirable deviation of the transmitted torque, in particular of the braking torque of a retarder, or at least not to the extent known. In particular, the design of the filling control device according to the invention should be simple and cost efficient as well as with low-maintenance requirements.

### SUMMARY OF THE INVENTION

The object of the invention is achieved with, and the present invention provides, a hydrodynamic machine exhibiting the following features:

A filling control device of a hydrodynamic machine, in particular for a retarder,
having a first inlet for supplying working medium for the hydrodynamic machine into the filling control device;
having a second inlet for supplying working medium from the hydrodynamic machine into the filling control device;
having a first outlet for discharging working medium into the hydrodynamic machine;
having a second outlet for discharging working medium from the hydrodynamic machine and/or working medium from a bypass, which carries working medium passed the hydrodynamic machine;
having a force transducer and/or displacement sensor or a port for such a sensor; wherein
all the aforementioned inlets and outlets together with the force transducer and/or displacement sensor or the port therefore are provided in a common control valve, which has a first and a second valve body, which are acted upon by the force transducer and/or displacement sensor to shift them together in such a way that they control at least indirectly the flow of working medium in the inlets and outlets as an open or closed-loop and/or between them according to the action exerted by the force transducer and/or displacement sensor as a result of their being shifted; and
the first valve body and the second valve body are shifted by means of a piston rod which can be shifted by the force transducer and/or displacement sensor;
the first valve body is acted upon in a direction of shift by the working medium pressure in the first inlet or by a pressure dependent thereon and
the second valve body when being shifted alters the pressure of the working medium and/or the free flow cross-section for working medium in the second inlet; and
the first valve body and the second valve body are connected to one another via the piston rod or another rigid element and/or an elastic element;
   characterised in that
the first valve body is connected elastically on the piston rod, and
a stationary stop is provided for the first valve body, against which the first valve body strikes when the second valve body is further shifted by means of the piston rod.

The filling control device according to the invention of a hydrodynamic machine, in particular of a retarder, has a first inlet for supplying working medium for the hydrodynamic machine into the filling control device. Moreover, a second inlet is provided for supplying working medium from the hydrodynamic machine into the filling control device. In addition to a first outlet for discharging working medium into the hydrodynamic machine, a second outlet is provided for discharging working medium from the hydrodynamic machine and/or working medium from a bypass, which carries the working medium past the hydrodynamic machine.

Subsequently, the working medium which is introduced via the first inlet into the filling control device is guided either via the first outlet into the hydrodynamic machine and flows from the hydrodynamic machine via the second inlet back into the filling control device, out of which it is discharged again via the second outlet, or the working medium inflowing via the first inlet into the filling control device can according to an advantageous embodiment be carried through a by-pass passed the hydrodynamic machine and exit, once it has flowed through the by-pass, which can be conveyed inside or outside the filling control device, through the second outlet out of the filling control device again.

An external working medium circuit, in particular a cooling circuit of a motor vehicle, is particularly advantageously connected to the first inlet and to the second outlet, so that the working medium (cooling medium), which is introduced via the first inlet into the filling control device, is fed again into the external circuit via the second outlet.

According to the invention, the filling control device has a force transducer and/or displacement sensor or a port for such a sensor so as to control in an open or closed loop fashion the flow of working medium in the inlets and outlets and/or between them with at least two valve bodies, as described below, according to the control force or to the control travel. A control pressure port can for instance be provided for supplying a control pressure, with which the opening condition of the control valve formed through the filling control device is determined. In particular, this control pressure port is the only control pressure port so that any opening condition (or closing condition) of the filling control device is controlled in an open or closed-loop fashion via a single control pressure.

Compressed air can for instance be supplied from a compressed air system.

If such a control pressure port is provided, a valve piston can for instance be acted upon by the control pressure which shifts the first valve body and the second valve body via a piston rod. The term piston rod should be understood as covering any mechanical element which can shift the first valve body and the second valve body according to the actuation by the force transducer and/or displacement sensor. Thus, the piston rod can for instance be designed as an elongated bar, in particular being solid or departing therefrom in the form of a hollow body. Also, the execution of the piston rod in the form of one or more spacing elements or still formed in a deviation therefrom is possible.

Alternately or additionally to providing a control pressure port, the valve bodies respectively the piston rod can be moved also via a pulling and/or pushing rod which a servomotor or similar catches. Such a pulling and/or pushing rod can also consist itself of the piston rod. A magnetic force transducer or displacement sensor could also be provided inside the control valve or connected thereto. Other force transducers and/or displacement sensors are possible.

According to the invention, said inlets and outlets together with the force transducer and/or displacement sensor or the port for such a sensor are provided in a common control valve, which has the first and the second valve body, which are acted upon by the force transducer and/or displacement sensor to shift them together in such a way that they control in an open or closed-loop fashion at least indirectly the flow of working medium in the inlets and outlets and/or between them according to the action exerted by the force transducer and/or displacement sensor as a result of their being shifted, whereas the shifting is triggered by said piston rod.

The first valve body is acted upon in a direction of shift by the working medium pressure in the first inlet or by a pressure dependent thereon. This dependent pressure can for instance be proportional to the working medium pressure in the first inlet.

The second valve body, when being shifted, alters the pressure of the working medium and/or the free flow cross-section for working medium in the second inlet. In this view, the embodiment according to the invention corresponds to a vast extent that of the document DE 10 2006 008 110 described initially.

The invention is based on the finding that the dependence described initially of the adjusted torque in the hydrodynamic machine, in particular of the braking torque of a retarder, on the engine speed of the internal combustion engine rests on a modification of the working medium pressure applied in the first inlet. Thus, this pressure varies especially when integrating the retarder in an external working medium circuit with the rotation speed of a feeding pump provided in this circuit, which is driven by the internal combustion engine. So far the consequence was that an increasing actuating force is exerted via the first valve body, which is rigidly connected to the piston rod, with increasing working medium pressure in the first inlet, on the piston rod and hence the second valve body which regulates the transmitted torque in the hydrodynamic machine. The second valve body hermetically closes with increasing actuating force the second inlet progressively and hence the free flow cross-section for the working medium, which flows in from the hydrodynamic machine into the filling control device, which causes an increased torque transmitted in the hydrodynamic machine, in particular of the braking torque. This effect is particularly strong when the first valve body has hermetically closed a by-pass provided to that effect and hence when no pressure compensation between both axial sides of the first valve body takes place any longer.

According to the invention, the first valve body and the second valve body are therefore connected to one another not only via the piston rod (or, as shown, another element which is not in the form of a rod) and/or via an elastic element, but rather the first valve body is also connected elastically on the piston rod (or the other rod element). Moreover, a stationary stop is provided for the first valve body, in particular in the valve housing, against which the first valve body strikes when the second valve body is further shifted by means of the piston rod. As the first valve body hits the stop, which is installed in particular on the side opposite to the pressurisation exerted by the working medium pressure in the first inlet, no overlapping force is applied via the first valve body to the piston rod when the pressure rises in the working medium pressure. Consequently, the undesirable increase in the torque transmitted in the hydrodynamic machine can be avoided as described.

The first valve body is advantageously supported via a first spring, in particular a pressure spring or a spiral pressure spring, on the piston rod. Additionally or alternately, the second valve body can be supported via a second spring, which is designed advantageously as a pressure spring, for instance a spiral pressure spring, on the piston rod and/or on the first valve body.

The second valve body should suitably be supported via the second spring on a first side of a protrusion of the piston rod, in particular in the form of a washer carried through the piston rod or built therethrough, and the first valve body is pushed by means of the first spring towards a second side of the protrusion, opposite the first side, until the first valve body strikes against the stationary stop, whereas said valve body rises from the protrusion, in particular from the washer, here called second washer, during further shift of the second valve body by means of the piston rod.

Alternately, the second valve body can be supported by means of the second spring on a first axial side of the first valve body, and the first valve body is supported by means of a second axial side, opposite to the first axial side via the first spring on the piston rod. In this form of embodiment, the first valve body advantageously slides on or in the piston rod, without hitting a mechanical stop of the piston rod.

The control valve can exhibit a third spring, advantageously in the form of a pressure spring, for instance a spiral pressure spring, by means of which the first valve body is supported on the valve housing, in particular to oppose the force of the first spring.

Besides, a third inlet can be provided for supplying working medium from the by-pass into the filling control device and a third outlet can be provided for discharging working medium into the by-pass, and the first valve body can vary the flow of working medium through the by-pass when being shifted due to more or less strong closing of the third inlet and/or of the third outlet, as well as adjust said flow with accuracy.

Generally, the first valve body will vary the flow of working medium through the first outlet when being shifted due to more or less strong closing of the first outlet and hence adjust said flow with accuracy. In intermediate positions of the first valve body, working medium which flows in via the first inlet into the filling control device is hence partially conveyed via the first outlet into the hydrodynamic machine and subsequently via the second inlet back into the filling control device and partially via the third outlet into the by-pass and further via the third inlet again into the filling control device, whereas subsequently the working medium carried via the third inlet and the second inlet into the filling control device is supplied together via the second outlet again into the external working medium circuit.

According to a first embodiment, the by-pass can consist of a pipework connected on the control valve, of a hose or another separate pipe. According to a second embodiment, the by-pass is formed itself by the filling control device respectively the control valve, inasmuch as a corresponding channel is provided therein, for instance in the valve housing.

The control valve, which in particular constitutes the filling control device on its own, can include a single valve housing, which however can be composed of several components. According to an advantageous embodiment, the valve housing exhibits a hollow body extending in axial direction, which is closed hermetically on both its front sides, respectively by a lid, an insert or similar. In an axial configuration, a front face can be formed immediately by the working medium outlet of the hydrodynamic machine, in particular by a retarder outlet, so that the working medium flows in axially into said hollow body.

The first valve body can be moveable axially inside the hollow body in such a way that it catches the hollow body in a seal-forming fashion with one or several control edges, so as to determine the flow of working medium through the control valve by its axial position.

The second spring, with which the second valve body is acted upon, which for instance opposes the pressure of the working medium in the second inlet and which is supported both on the first valve body respectively on the piston rod, the latter in particular via a protrusion, as for instance said washer, advantageously includes a smaller resilience than the first spring and/or third spring.

A hydrodynamic machine, is designed in particular as a water retarder, can get by with a single filling control device for controlling the filling, if the filling control device is formed according to the invention and in particular connected directly on the hydrodynamic machine.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a first preferred embodiment of the filling control device according to the invention in a cross-section through the longitudinal axis and of a first position of the second valve piston, in which no working medium is conveyed to the hydrodynamic machine;

FIG. 2 shows the filling control device of FIG. 1 in a second position, in which the whole working medium conveyed to the filling control device is fed into the hydrodynamic machine; and shows a second form of embodiment of the filling control device according to the invention, comprising a single control valve, in a first position, in which no working medium is conveyed to the hydrodynamic machine;

FIG. 3 shows a second form of embodiment of the filling control device according to the invention, comprising a single control valve, in a first position, in which no working medium is conveyed to the hydrodynamic machine.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

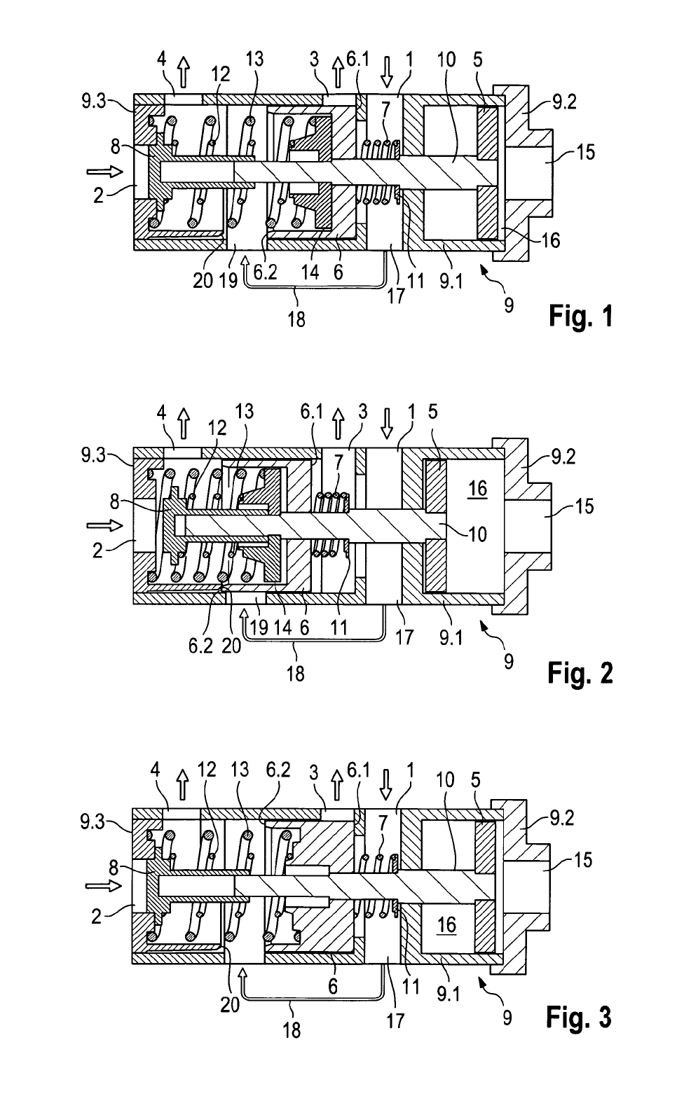

FIG. 1 illustrates a filling control device realised according to the invention in the form of a control valve having a single valve housing 9, which includes a hollow body 9.1 extending in axial direction of the control valve, which body can have for instance a circular, rectangular or square cross-section, whereas the hollow body 9.1 is closed hermetically at both its axial ends respectively through a connected cover element, and every cover element has a flow directing passage in the illustrated form of embodiment. The first cover element (right in FIG. 1), which in this instance is set up in the form of a hood 9.2 from outside on the hollow body 9.1, exhibits a control pressure port 15 for the control valve, whereas this control pressure port 15 is the only control pressure port. The latter can for instance be connected to a compressed air system, so that the position of the valve piston 5, which slides in axial direction inside the hollow body 9.1, adjusts itself depending on the control pressure in the control pressure port 15 respectively in a control pressure space 16, in which the control pressure port 15 emerges and which is limited by the valve piston 5. In this instance, the valve piston 5 is carried by a piston rod 10 and can be designed as a single-part therewith.

The valve piston 5 respectively the piston rod 10 is prestressed via an elastic element, here a first spring 7, such as for example a spiral pressure spring, against a first valve body 6. According to the first exemplary embodiment, the first spring 7 is supported on the piston rod 10, for instance, as illustrated in FIGS. 1 and 2, via a first washer 11, which is supported in turn on the piston rod 10. The other end of the first spring 7 is supported on a front side of the first valve body 6. Consequently, the first spring 7 is arranged via the piston rod 10 between the valve piston 5 and the first valve body 6 and prestresses the valve piston 5 and the first valve body 6 against one another.

The piston rod 10 extends in longitudinal direction of the filling control device substantially through the whole control valve. Said piston is for example passed through the limits of the control pressure space 16. The first valve body 6 is hence attached slidingly on the piston rod 10 in such a way that it can move in axial direction of the piston rod 10 relatively along said rod. In this instance, the first valve body 6 encloses the piston rod 10 in the circumferential direction and is arranged coaxially respectively aligned therewith.

Moreover, a second valve body 8 is provided, which is installed (left side in FIG. 1) on the front face of the first valve 6 facing away from the valve piston 5 in the region of the ends of the piston rod 10 which is applied to the valve piston 5. In this instance, the second valve body 8 is arranged in such a way that it succeeds in accommodating the piston rod 10 slidingly in its internal section. For example, the second valve body 8 is built in the form of a sleeve on its end pointing to the piston rod 10.

The second axial end of the control valve (left on FIG. 1) is closed hermetically by an insert 9.3, which in turn carries a flow directing opening. This flow directing opening is the second inlet 2, which is acted upon by the working medium from the working medium outlet of the hydrodynamic machine (non-represented). The insert 9.3 can for instance be part of the housing of the hydrodynamic machine, in particular of the retarder, which forms the working medium outlet of the hydrodynamic machine. In such a case, the filling control device respectively the illustrated control valve is accordingly connected axially on the working medium outlet of the hydrodynamic machine. If no flow directing element is interposed, the second inlet 2 is at the same time the working medium outlet of the hydrodynamic machine, in particular of the retarder.

The second valve body 8 is prestressed via a second spring 12 against the piston rod 10 and hence against the valve piston 5, and admittedly in the same direction as the first valve body 6. In the present case, the second spring 12 is supported on the one hand on one landing of the second valve body 8 and on the other hand via a second washer 14, which is attached to the piston rod 10 secured against slipping or is designed as a single-part therewith.

The second spring 12 hence determines the force with which the valve piston 5 presses via the piston rod 10 on the second valve body 8 to oppose the pressure of the working medium in the second inlet 2 on the side of the second valve body 8, which side faces the second inlet 2. The second spring 12 is hence supported by the pressure of the working medium on the side of the second valve body 8 (on the back of the piston plate which can close hermetically the second inlet 2) facing away from the second inlet 2.

Moreover, a third spring 13 is provided which is supported on the one hand on the insert 9.3 and consequently on the valve housing 9 and on the other hand on the piston rod 10, in this instance again via the second washer 14. The third spring 13 opposes the compression force of the control pressure in the control pressure port 15 respectively in the control pressure space 16, or quite generally opposes the control force with which the piston rod 10 is pressed in the direction of the second inlet 2. The third spring 13 hence enables to generate a reset force in order to reset the piston rod 10 and in this instance the valve piston 5 to oppose the control pressure.

In the illustrated embodiment variation, the second spring 12 is enclosed by the third spring 13 in circumferential direction. Besides, the second spring 12 will generally show significantly smaller resilience than the third spring 13.

FIG. 1 illustrates moreover the first inlet 1, over which working medium flows in from the external working medium circuit (not shown) into the control valve, and from there further to a third outlet 17 into a by-pass 18, which bypasses the hydrodynamic machine (not shown). From the by-pass 18, the working medium flows again back into the control valve, and more precisely via a third inlet 19. The whole working medium, which has flowed in via the first inlet 1 into the control valve, hence flows in the position of the valve piston 5 illustrated in FIG. 1, which is in its rear end position, also via the third inlet 19 into the control valve, because also the first valve body 6 is pressed against the third spring 13 in its rear end position by a stop in the valve housing 9 and hence hermetically closes the first outlet 3, which is connected to the working medium inlet of the hydrodynamic machine. On the grounds that hence also no working medium flows out from the hydrodynamic machine to the second inlet 2, the pressure exerted on the side of the second valve body 8 pointing to the second inlet 2 is minimal and outweighs the compression force of the second spring 12, so that the second valve body 8 sits closely to the second inlet 2 fully sealingly on the housing 9 respectively on the insert 9.3. Due to this completely hermetic seal of the second inlet 2, even a vacuum can be generated in the hydrodynamic machine respectively in its workspace.

From the third inlet 19, the working medium fed via the by-pass 18 flows to the second outlet 4 and via said outlet back into the external working medium circuit. The pressure of the working medium in the respectively upstream of the second outlet 4 acts accordingly in the same direction on the second valve body 8, as the second spring 12.

The working medium may accordingly circulate in the external working medium circuit in the position illustrated in FIG. 1 (first axial end position of the first valve body 6) without flowing through the hydrodynamic machine. The illustrated control position of the control valve is hence also designated as the idle position.

As can be easily seen in FIG. 1, the illustrated idle position will always be engaged, if the control pressure is minimal or pressureless in the control pressure port 15 respectively in the control pressure space 16 and hence the force of the third spring 13 prevails. The force of the first spring 7 has hence no additional influence since the third spring 13 presses the second washer 14 against a stop provided on the piston rod 10, hence the resilience of the third spring 13 is introduced directly, that is to say without additional interposition of a spring into the piston rod 10 and the first spring 7 only sees to it that the first valve body 6 does not rise from the second washer 14, which however was the case with the stop provided in the valve housing 9.

FIG. 2 shows a second axial end position of the valve piston 5, which is opposite the first axial end position shown in FIG. 1. In order to bring the control piston 5 into this second axial end position 5, the control pressure in the control pressure port 15 respectively in the control pressure space 16 has been increased with respect to the state shown in FIG. 1 so far that the piston rod 10 has been moved into the second axial end position together with the valve body 5 and the second washer 14 to oppose the force of the third spring 13 in the direction of the second inlet 2. In this context, the first valve body 6 has moved, first of all due to the compression force transmitted via the first spring 7 from the piston rod 10 to said valve body, synchronously with the piston rod 10. This synchronous movement could however not cover the whole stroke travelled by the piston rod 10, since beforehand the first valve body 6 has hit a stop 20 in the valve housing 9, in this instance made of the insert 9.3, and was blocked against any further shift in the direction of the second inlet 2. The consequence of this blockage is that the force which was transmitted to the first valve body 6, until the first valve body 6 could hit the valve housing 9, and through the construction of the first valve body 6 on the second washer 14 also via the second spring 12 to the second valve body 8 now cannot be exerted upon the second valve body 8 any longer after hitting the stop, since the second washer 14 rises from the first valve body 6 due to the further shift of the piston rod 10 and only also sits closely to the protrusion of the piston rod 10. Consequently, after the second washer 14 has risen from the first valve body 6, the force which is transmitted via the second washer 14 and the second spring 12 to the second valve body 8 is then only determined by the force applied to the piston rod 10 in the direction of the second inlet 2. This is significant since, contrary to the force acting in the direction of the second inlet 2 upon the first valve body 6, this force is extensively or completely independent of any increase in the working medium pressure on the first inlet 1. Such an increase in the working medium pressure occurs for instance on the first inlet 1 then if a pump provided in the external working medium circuit rotates with a comparatively higher rotation speed, for instance because it is driven by the combustion engine of a motor vehicle according to the engine speed. The increased working medium pressure exerted on the first inlet 1 acts upon an axial side of the first valve body 6 and presses it more strongly in the direction of the second outlet 2. This is valid especially when the by-pass 18, as shown in FIG. 2, is closed hermetically by the first valve body 6 so that no pressure compensation takes place any longer between both axial sides of the first valve body 6.

As can be seen, the first valve body 6, in its second axial end position shown in FIG. 2 and in which it sits closely to the stop 20 in the valve housing 9 respectively the insert 9.3, releases the first outlet 3 altogether and hermetically closes the third inlet 19 to that end and hence the by-pass 18. Consequently, the working medium flowing in through the first inlet 1 flows altogether through the first outlet 3 and further into the hydrodynamic machine and from there into the second inlet 2. Due to the increased pressure in the second inlet 2 compared to the switching position shown in FIG. 1, the second valve body 8 is raised from its valve seat, which in this instance is formed by the insert 9.3, by opposing the force of the second spring 12, so that the working medium can flow from the hydrodynamic machine past the second valve body 8 and back into the external working medium circuit through the second outlet 4.

Since in the illustrated second axial end position of the valve piston 5 the second valve body 8 sits flush closely to the piston rod 10 respectively in this instance against the second washer 14, which in turn abuts against the piston rod 10, the relatively “soft” second spring 12 does not play any part any longer. Thus, particularly high pressures in the workspace of the hydrodynamic machine can be controlled in an open or closed-loop fashion by varying the control pressure and hence the axial position of the piston rod 10 and of the second valve body 8 sitting closely thereto, which enables to generate significantly larger braking torques with accuracy with a retarder.

In particular, the only object of the second spring 12 is to see to it that in the switched off state of the hydrodynamic machine (whose working medium outlet is respectively the second inlet 2) the second inlet 2 is closed fully hermetically, whereas conversely its resilience is defeated as soon as a significant flow of working medium is available on the second inlet 2.

Naturally, also axial intermediate positions between both axial end positions shown in FIGS. 1 and 2 are possible. Thus, the second valve body 6 can, in a non-illustrated intermediate position, partially release the first outlet 3, via which working medium can flow in the direction of the hydrodynamic machine, and at the same time partially seal the third inlet 19, so that in particular the flow pressure is increased in the by-pass 18. A fraction of the working medium, which flows via the first inlet 1 into the control valve, flows consequently via the first outlet 3 into the hydrodynamic machine, and the rest of this working medium flows via the by-pass 18 into the third inlet 19 and from there to the second outlet 4 back into the external working medium circuit. The distribution of the working medium from the first inlet 1 to the by-pass 18 and the hydrodynamic machine is determined by the magnitude of the control pressure and the resilience of the third spring 13, and at the same time the first spring 7 sees to it that the first valve body 6 still sits closely to the second washer 14, as long as it has not hit said stop 20 in the valve housing 9. It means that the first spring 7 remains in its prestressed condition, without being compressed and hence also does not apply any additional force to oppose the movement of the valve piston 5 towards the second inlet 2.

Also in the non-illustrated axial intermediate position, the second valve body 8 is raised from its valve seat and the insert 9.3 by opposing the force of the second spring 12 and releases the second inlet so that the working medium can flow from the hydrodynamic machine with only minimal pressure in the workspace of the hydrodynamic machine via the second inlet 2 and the second outlet 4 into the external working medium circuit. The presence of a hydrodynamic retarder hence enables to adjust particularly small braking torques which are smaller than the braking torques which are achieved with retarders fitted with a switching valve on the inlet, which only knows an on and off state, combined with a regulating valve on the outlet.

If then the control pressure is increased further the second axial end position of the valve piston 5 illustrated in FIG. 2 and hence of the first valve body 6 is achieved.

In the illustrated embodiment, the second valve body 6 includes two control edges 6.1 and 6.2 which respectively cooperate with the inner face of the hollow body 9.1. The first control edge 6.1 enables to control the flow cross-section in the first outlet 3 and the second control edge 6.2 enables to control the flow cross-section in the third inlet 19 according to the position of the second valve body 6 relative to the hollow body 9.1.

It is also quite possible to form the by-pass 18 completely in the control valve so that said by-pass runs in particular inside the valve housing 9. Hereby two ports can again be dispensed with.

A further embodiment of the filling control device according to the invention is shows in FIG. 3 with substantially the same elements as in the previous figures. The latter are consequently provided with identical reference signs. Here also, a first spring 7, which braces the valve piston 5 against the first valve body 6, is shown. In this example, only the second washer 14 was dispensed with. Now, the second spring 12 as well as the third spring 13 support themselves directly on the first valve body 6, through which the force which is exerted upon the piston rod 10 via the valve piston 5 is constantly transmitted to the first valve body 6 via the first spring 7, since parallel to this force progression, no force is transmitted any longer from the third spring 13 via a mechanical stop 20 to the piston rod 10. Contrary thereto, the force which the third spring 13 exerts as a counterforce upon the valve piston 5 and the piston rod 10 is transmitted constantly via the first spring 7. As long as the first valve body is not moved axially in the direction of the second inlet so far that it hits the stop 20 in the valve housing 9 respectively the insert 9.3, the third spring 13 and the first spring 7 accordingly form a force scale.

Incidentally, the operating mode corresponds to the form of embodiment illustrated in FIG. 3, however that of the embodiment illustrated in FIGS. 1 and 2.

The filling control device of a hydrodynamic machine, in particular of a hydrodynamic retarder, can, according to the embodiments illustrated in the figures of a filling control device according to the invention, only consist of a control valve fitted with a single valve housing 9, comprising seven ports and three valve bodies respectively valve pistons axially mobile in the valve housing 9, which are prestressed by pressure springs. When the by-pass 18 is formed completely by the control valve, and runs in particular inside the valve housing 9, the valve housing 9 can even get by with only five ports.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 First inlet
2 Second inlet
3 First outlet
4 Second outlet
5 Valve piston
6 First valve body
6.1 Control edge
6.2 Control edge
7 First spring
8 Second valve body
9 Valve housing
9.1 Hollow body
9.2 Hood
9.3 Insert
10 Piston rod
11 First washer
12 Second spring
13 Third spring
14 Second washer
15 Control pressure port
16 Control pressure space
17 Third outlet
18 By-pass
19 Third inlet
20 Stop

What is claimed is:

1. A filling control device of a hydrodynamic machine which is a retarder, said filling control device comprising:
a first inlet for supplying a working medium for the hydrodynamic machine into the filling control device;
a second inlet for supplying said working medium from the hydrodynamic machine into the filling control device;
a first outlet for discharging said working medium into the hydrodynamic machine;
a second outlet for discharging at least one of said working medium from the hydrodynamic machine and said working medium from a bypass which carries said working medium passed the hydrodynamic machine;
one of (a) at least one of a force transducer and a displacement sensor and (b) a port for at least one of said force transducer and said displacement sensor;
a common control valve including a first valve body and a second valve body, each of said first inlet, said second inlet, said first outlet, and said second outlet together with one of (a) at least one said force transducer and said displacement sensor and (b) said port therefore being provided in said common control valve, said first valve body and said second valve body being acted upon by at least one of said force transducer and said displacement sensor to shift said first valve body and said second valve body together in such a way that said first valve body and said second valve body control at least indirectly a flow of said working medium in said first inlet, said second inlet, said first outlet, and said second outlet at least one of (a) as one of an open loop and a closed loop and (b) between said first inlet, said second inlet, said first outlet, and said second outlet according to an action exerted by at least one of said force transducer and said displacement sensor as a result of said first valve body and said second valve body being shifted;
at least one of (a) one of a piston rod and another rigid element and (b) an elastic element, said first valve body and said second valve body being shifted by way of said piston rod which can be shifted by at least one of said force transducer and said displacement sensor, said first valve body being acted upon in a direction of shift one of by a working medium pressure in said first inlet and by a pressure dependent thereon, said second valve body when being shifted altering at least one of said working medium pressure and a free flow cross-section for said working medium in said second inlet, said first valve body and said second valve body being connected to one another via at least one of (a) one of said piston rod and said other rigid element and (b) said elastic element, said first valve body being connected elastically on said piston rod; and
a stationary stop which is provided for said first valve body, said first valve body striking against said stationary stop when said second valve body is further shifted by way of said piston rod.

2. The filling control device according to claim 1, further comprising a first spring, wherein said first valve body is supported via said first spring on said piston rod, said first spring being one of a pressure spring and a spiral pressure spring.

3. The filling control device according to claim 2, further comprising a second spring, wherein said second valve body is supported via said second spring, at least one of on said piston rod and on said first valve body, said second spring being one of a pressure spring and a spiral pressure spring.

4. The filling control device according to claim 3, wherein said piston rod includes a protrusion having a first side and a second side opposite said first side, said second valve body being supported via said second spring on said first side of said protrusion of said piston rod, said first valve body being supported by way of said first spring to said second side of said protrusion of said piston rod, said first valve body being pushed by way of said first spring towards said second side of said protrusion until said first valve body strikes against said stationary stop.

5. The filling control device according to claim 4, wherein said protrusion is formed as a washer one of carried through said piston rod and built through said piston rod.

6. The filling control device according to claim 3, wherein said first valve body includes a first axial side and a second axial side opposite said first axial side, said second valve body being supported by way of said second spring on said first axial side of said first valve body, said first valve body being supported by way of said second axial side via said first spring on said piston rod.

7. The filling control device according to claim 6, wherein said first valve body can slide one of inside and on said piston rod free from a mechanical stop on said piston rod.

8. The filling control device according to claim 7, further comprising a third spring and a valve housing, the filling control device being a control valve, said first valve body being supported on said valve housing of said control valve by way of said third spring to oppose a force of said first spring, said third spring being one of a pressure spring and a spiral pressure spring.

9. The filling control device according to claim 8, further comprising a third inlet for supplying said working medium from said bypass into the filling control device and a third outlet for discharging said working medium into said bypass, said first valve body varying said flow of said working medium through said bypass when said first valve body is shifted due to more or less a strong closing of at least one of said third inlet and said third outlet.

10. The filling control device according to claim 9, wherein said first valve body varies said flow of said working medium through said first outlet when said first valve body is shifted due to more or less a strong closing of said first outlet.

11. A hydrodynamic machine, which is a retarder, having a working medium inlet and a working medium outlet, said hydrodynamic machine comprising:
a filling control device including:
a first inlet for supplying a working medium for the hydrodynamic machine into said filling control device;
a second inlet for supplying said working medium from the hydrodynamic machine into said filling control device, said working medium outlet being connected to said second inlet for conveying said working medium;
a first outlet for discharging said working medium into the hydrodynamic machine, said working medium inlet being connected to said first outlet for conveying said working medium;
a second outlet for discharging at least one of said working medium from the hydrodynamic machine and said working medium from a bypass which carries said working medium passed the hydrodynamic machine;
one of (a) at least one of a force transducer and a displacement sensor and (b) a port for at least one of said force transducer and said displacement sensor;
a common control valve including a first valve body and a second valve body, each of said first inlet, said second inlet, said first outlet, and said second outlet together with one of (a) at least one said force transducer and said displacement sensor and (b) said port therefore being provided in said common control valve, said first valve body and said second valve body being acted upon by at least one of said force transducer and said displacement sensor to shift said first valve body and said second valve body together in such a way that said first valve body and said second valve body control at least indirectly a flow of said working medium in said first inlet, said second inlet, said first outlet, and said second outlet at least one of (a) as one of an open loop and a closed loop and (b) between said first inlet, said second inlet, said first outlet, and said second outlet according to an action exerted by at least one of said force transducer and said displacement sensor as a result of said first valve body and said second valve body being shifted;
at least one of (a) one of a piston rod and another rigid element and (b) an elastic element, said first valve body and said second valve body being shifted by way of said piston rod which can be shifted by at least one of said force transducer and said displacement sensor, said first valve body being acted upon in a direction of shift one of by a working medium pressure in said first inlet and by a pressure dependent thereon, said second valve body when being shifted altering at least one of said working medium pressure and a free flow cross-section for said working medium in said second inlet, said first valve body and said second valve body being connected to one another via at least one of (a) one of said piston rod and said other rigid element and (b) said elastic element, said first valve body being connected elastically on said piston rod; and
a stationary stop which is provided for said first valve body, said first valve body striking against said stationary stop when said second valve body is further shifted by way of said piston rod.
